(19) United States
(12) Patent Application Publication
(10) Pub. No.: US 2011/0018980 A1
(43) Pub. Date: Jan. 27, 2011

(54) STEREOSCOPIC DISPLAY APPARATUS

(75) Inventor: Chung-Jyh Lin, YongKang (TW)

Correspondence Address: Flash Intellectual Property, Inc.;Attn. Cheng-Ju Chiang, P.O. Box 766, Chino, CA, 91708, US

(73) Assignee: Aussmak Optoelectronics Corp., YongKang City (TW)

(21) Appl. No.: 12/790,849

(22) Filed: May 30, 2010

(30) Foreign Application Priority Data
Jul. 22, 2009 (TW) 098124727

(51) Int. Cl. H04N 13/04

(52) U.S. Cl. 348/53; 348/56; 348/E13.075

(57) ABSTRACT

A stereoscopic display apparatus is cooperated with a shutter apparatus. The stereoscopic display apparatus includes a light-emitting diode (LED) display unit. The LED display unit has a plurality of LEDs. The LED display unit alternately outputs a left-eyed image and a right-eyed image.

### CROSS REFERENCE TO RELATED APPLICATIONS

This Non-provisional application claims priority under 35 U.S.C. §119(a) on Patent Application No(s). 098124727 filed in Taiwan, Republic of China on Jul. 22, 2009 the entire contents of which are hereby incorporated by reference.

### BACKGROUND OF THE INVENTION

1. Field of Invention

The invention relates to a display apparatus and, in particular, to a stereoscopic display apparatus.

2. Related Art

The display apparatus has become an indispensible element of our daily life. The display apparatus has been developed to achieve high image quality and high resolution, and is further developed in the field of stereoscopic display technology now. On the other hand, due to the maturely developed and popularized liquid crystal display (LCD) technology, the LCD apparatus has become the main development in the display field. The stereoscopic LCD, combining the LCD technology and the stereoscopic display technology, can display images by two methods. For one method, the user views the images without the glasses (naked-eye method), and for the other, the user views the images through the specific glasses.

For the stereoscopic LCD apparatus that displays based on the naked-eye method, a light-shielding layer is necessary to be disposed on the display panel for shielding the left-eyed image and the right-eyed image alternately, so that the left-eyed image output by the display panel can be transmitted to the left eye of the viewer by the refraction of the lens and the right-eyed image output by the display panel can be transmitted to the right eye of the viewer by the refraction of the lens. So, the eyes of the viewer can receive different images that can form the stereoscopic image with binocular parallax. In this case, the pixels of the stereoscopic LCD apparatus should be divided into two display areas for the left eye and the right eye respectively, but the resolution of the display apparatus is lowered. Besides, the light will be fixed in direction after passing through the light-shielding layer and the lens, so if the viewer moves during viewing the images or plural viewers are located at different positions to view the images, they will get the bad stereoscopic effect.

In addition, for the stereoscopic display apparatus cooperated with shutter glasses, because the response of the LC molecules is slower, they will not be oriented in time to alternately display the left-eyed image and the right-eyed image, and thus motion blur and bad stereoscopic effect will be caused.

Therefore, it is an important subject to provide a stereoscopic display apparatus with high resolution and good stereoscopic effect.

### SUMMARY OF THE INVENTION

In view of the foregoing subject, an object of the invention is to provide a stereoscopic display apparatus with high resolution and good stereoscopic effect.

To achieve the above, a stereoscopic display apparatus of the invention cooperated with a shutter apparatus comprises a light-emitting diode (LED) display unit. The LED display unit has a plurality of LEDs. The LED display unit alternately outputs a left-eyed image and a right-eyed image.

As mentioned above, because LED has a property of fast response, the LED display unit of the stereoscopic display apparatus of the invention can rapidly output a left-eyed image and a right-eyed image alternately. Accordingly, the black frame does not need to be inserted between the left-eyed image and the right-eyed image, so as to increase the frame rate. Besides, the stereoscopic display apparatus displays the left-eyed image and the right-eyed image by an alternate method, so the pixels of the LED display unit do not need to be divided into two display areas for the left eye and the right eye respectively. Therefore, the stereoscopic display apparatus of the invention can provide the stereoscopic images with high resolution and high quality when the viewer views the stereoscopic display apparatus through the shutter apparatus (such as shutter glasses). In addition, the stereoscopic display apparatus of the invention can be applied to the outdoor display as the large-sized outdoor display apparatus, and the user can also obtain the stereoscopic images with high resolution and high quality when viewing the stereoscopic display apparatus by using the shutter apparatus.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a schematic diagram of a stereoscopic display apparatus according to a preferred embodiment of the invention;

FIG. 2 is a schematic view of the stereoscopic display apparatus in FIG. 1;

FIG. 3 is a schematic diagram of a variation of the stereoscopic display apparatus according to the preferred embodiment of the invention;

FIG. 4 is a schematic exploded diagram of the shutter apparatus cooperated with the stereoscopic display apparatus according to the preferred embodiment of the invention; and

FIG. 5 is a schematic diagram of a variation of the stereoscopic display apparatus according to the preferred embodiment of the invention.

### DETAILED DESCRIPTION OF THE INVENTION

The present invention will be apparent from the following detailed description, which proceeds with reference to the accompanying drawings, wherein the same references relate to the same elements.

### First Embodiment

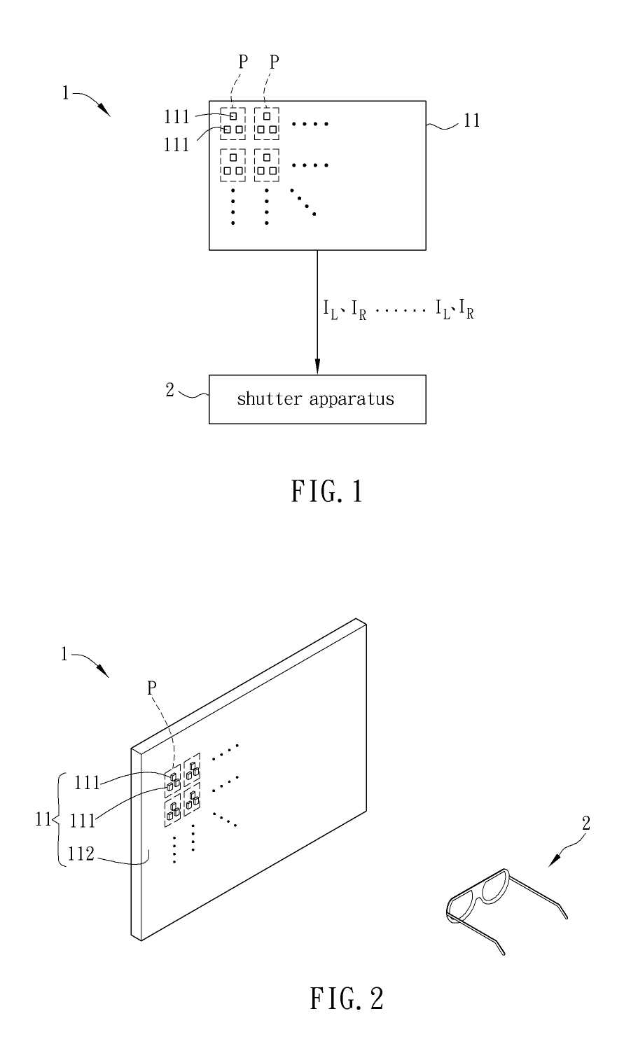

FIG. 1 is a schematic diagram of a stereoscopic display apparatus 1 according to a preferred embodiment of the invention, and FIG. 2 is a schematic view of the stereoscopic display apparatus 1. As shown in FIGS. 1 and 2, the stereoscopic display apparatus 1 cooperates with a shutter apparatus 2, which is located between the human eyes and the stereoscopic display apparatus 1. That is, the shutter apparatus 2 is located on the optical path from the human eyes to the stereoscopic display apparatus 1. A user can view the stereoscopic display apparatus 1 through the shutter apparatus 2. The stereoscopic display apparatus 1 can be, for example, a small or medium-sized display apparatus used at home (e.g. TV, digital photo frame or monitor), a display apparatus used in movie theater, a screen of an electronic apparatus, an outdoor medium or large-sized display apparatus, an indicator board, or a billboard. The shutter apparatus 2 can be a shutter glasses for example, or other apparatuses that can alternately shield the left eye and the right eye of a user, such as the shutter apparatus having mechanical rotatable devices or moveable devices. Here, the shutter apparatus 2 is a pair of glasses for example.

To be noted, the stereoscopic display apparatus 1 is not a head-mounted display, but separated from the shutter apparatus. For instance, the shutter apparatus 2 can be located apart from the stereoscopic display apparatus 1 for one meter or more to provide better view quality. When the user wears the shutter apparatus 2 and views the stereoscopic display apparatus 1, the user can shift the position and view the images, which means the distance and relative position between the shutter apparatus 2 and the stereoscopic display apparatus 1 is changeable. Besides, a single stereoscopic display apparatus 1 can be viewed by plural users, each wearing a shutter apparatus 2. The stereoscopic display apparatus 1 can have a size more than 40 inches diagonally so as to provide better view effect. Furthermore, the screen of the stereoscopic display apparatus 1 can be a planar surface, a curved surface, a hemisphere (a user can view images in the hemisphere), a sphere, or an annularity for panorama.

The stereoscopic display apparatus 1 has a light-emitting diode (LED) display unit 11 which has a plurality of LEDs 111. The LEDs can be LED dies or LED packages, and can be red LEDs, green LEDs, blue LEDs, yellow LEDs, white LEDs, or any of their combinations. The LEDs 111 can form a plurality of pixels P, and in one pixel P there can be a single LED 111, or two or more LEDs 111 that emit different colored lights. Here, there are three LEDs 111 emitting three colored lights (e.g. red, green and blue lights) in one pixel P. Alternatively, there can be four or more LEDs in one pixel P, such as two green LEDs, one red LED, and one blue LED.

The LED display unit 11 alternately outputs a left-eyed image I_{L} and a right-eyed image I_{R} in a frame rate which can be 60 Hz or more, or the multiple of 60 Hz. To be noted, that the LED display unit 11 alternately outputs the left-eyed image I_{L} and the right-eyed image I_{R} means the LED display unit 11 outputs the left-eyed image I_{L} at the current time period and outputs the right-eyed image I_{R} at next time period, and according to this sequence the LED display unit 11 outputs the left-eyed image I_{L} and the right-eyed image I_{R} rapidly. In this case, the left-eyed image I_{L} and the right-eyed image I_{R} can be overlapped partially, or adjacent to each other with an interval or with no interval. The left-eyed image I_{L} and the right-eyed image I_{R} are different and have binocular parallax, so that a stereoscopic image can be formed after they are alternately transmitted to the human eyes at a high rate.

The LED display unit 11 can further have a carrier 112, such as a lead frame, a substrate or a circuit board. The LEDs 111 are disposed on the carrier 112 and electrically connected with a circuit layer of the carrier 112.

Because the LED 111 is capable of responding fast, the LEDs 111 forming pixels P can rapidly turn on and turn off according to the left-eyed image signals and the right-eyed image signals to generate the left-eyed images I_{L} and the right-eyed images I_{R} alternately (for example, the left-eyed image I_{L} is output in the current frame and the right-eyed image I_{R} is output at the next frame) at a high rate. Therefore, the black frame (black frame insertion technology) does not need to be inserted between the left-eyed images I_{L} and the right-eyed images I_{R}, so as to increase the frame rate. Besides, because the stereoscopic display apparatus 1 outputs the left-eyed images I_{L} and the right-eyed images I_{R} in an alternate way, the LED display unit 11 does not need to be divided into two display areas for the left and right eyes (for the left-eyed pixels and the right-eyed pixels) respectively. Therefore, when a user uses the shutter apparatus 2 (such as shutter glasses) to view the stereoscopic display apparatus 1, the user can view the stereoscopic images with high resolution and high quality.

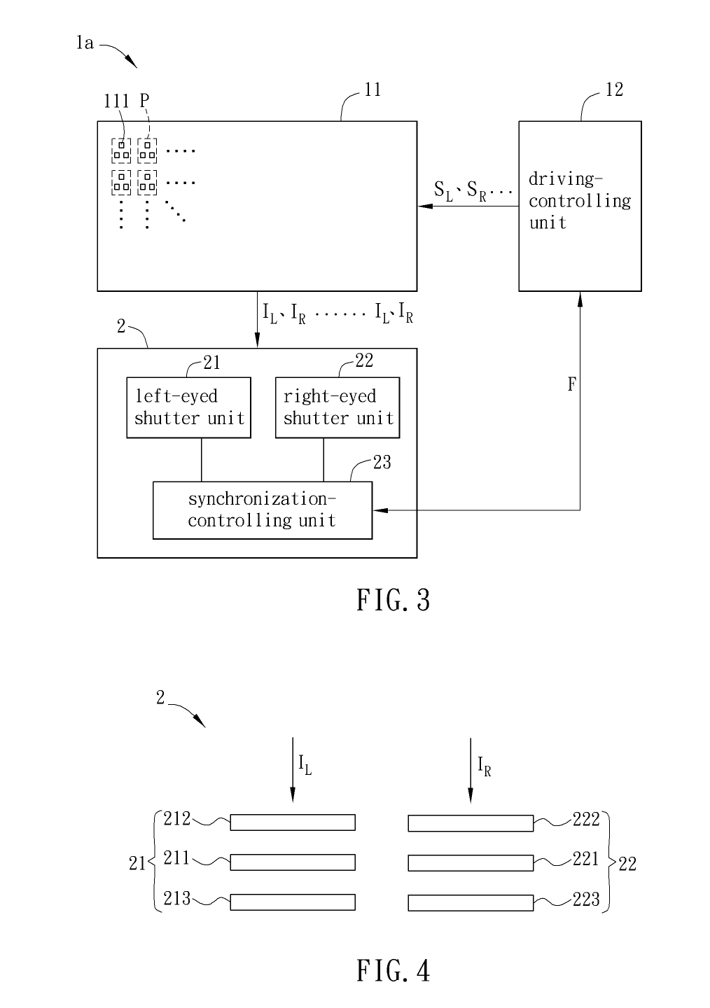

FIG. 3 is a schematic diagram of a stereoscopic display apparatus 1a in another aspect. As shown in FIG. 3, the stereoscopic display apparatus 1a can further have a driving-controlling unit 12 which is electrically connected with the LED display unit 11 and alternately outputs a left-eyed image signal S_{L} and a right-eyed image signal S_{R} according to a frequency signal F to drive the LED display unit 11. Thereby, the LED display unit 11 can generate the left-eyed image I_{L} and the right-eyed image I_{R} respectively according to the left-eyed image signal S_{L} and the right-eyed image signal S_{R}, and the left-eyed images I_{L} and the right-eyed images I_{R} are output according to the frequency signal F. The frame rate of the left-eyed image I_{L} and the right-eyed image I_{R} is the same as the frequency of the frequency signal F. The frequency signal F can be determined by the driving-controlling unit 12 or the shutter apparatus 2.

To be noted, the left-eyed image signal S_{L} and the right-eyed image signal S_{R} can respectively comprise scan line signals and/or data line signals or the like for controlling and driving the LED display unit 11.

The shutter apparatus 2 cooperated with the stereoscopic display apparatus 1a can have a left-eyed shutter unit 21, a right-eyed shutter unit 22 and a synchronization-controlling unit 23 which is electrically connected with the left-eyed shutter unit 21 and the right-eyed shutter unit 22.

The synchronization-controlling unit 23 can control the left-eyed shutter unit 21 and the right-eyed shutter unit 22 according to the frequency signal F, so that the user can alternately view the left-eyed image I_{L} through the left-eyed shutter unit 21 and view the right-eyed image I_{R} through the right-eyed shutter unit 22. The frequency signal F can be transmitted between the driving-controlling unit 12 and the synchronization-controlling unit 23 through a wired transmission (e.g. through a wire connecting the stereoscopic display apparatus 1a and the shutter apparatus 2) or a wireless transmission (e.g. Bluetooth, infrared, radio frequency or laser transmission).

FIG. 4 is a schematic exploded diagram of the shutter apparatus 2. As shown in FIGS. 3 and 4, the shutter apparatus 2 is a shutter glasses for example, and the left-eyed shutter unit 21 has a liquid crystal device 211 and two polarizing elements 212, 213 and the right-eyed shutter unit 22 has a liquid crystal device 221 and two polarizing elements 222, 223. To be noted, the liquid crystal devices 211, 221 and the polarizing elements 212, 213, 222, 223 are not drawn according to the actual scale, and the glasses frame and rims omitted here can be designed in various types.

Each of the liquid crystal devices 211 and 221 can have two substrates and a liquid crystal layer disposed between the substrates, and the liquid crystal layer can include Twisted Nematic (TN) liquid crystal, Super Twisted Nematic (STN) liquid crystal, Double layer Super Twisted Nematic (DSTN) liquid crystal, Cholesteric liquid crystal, or Blue Phase liquid crystal. The liquid crystal device 211 is disposed between the polarizing elements 212 and 213, and the liquid crystal device 221 is disposed between the polarizing elements 222 and 223. The polarization axes of the polarizing elements 212 and 213 can be perpendicular, and those of the polarizing elements 222 and 223 can be perpendicular, too. By the control of the synchronization-controlling unit 23, the left-eyed shutter unit 21 and the right-eyed shutter unit 22 can effectively shield the light. Of course, in order to improve the light shielding effect, three or more polarizing elements can be used in a single shutter unit.

Because the liquid crystal devices 211 and 221 can be oriented by the voltage control to alter the direction of polarization, the liquid crystal devices 211 and 221 cooperated with the polarizing elements 212, 213, 222, 223 can generate the light-shielding and the light-permeable effects. Thereby, the left-eyed shutter unit 21 can alternately shield the light and let the light pass through. Meanwhile, the right-eyed shutter unit 22 can alternately let the light pass through and shield the light, contrary to the left-eyed shutter unit 21. Therefore, the user can alternately view the left-eyed image I_{L} through the left-eyed shutter unit 21 (when the left-eyed shutter unit 21 lets the light pass through, and the right-eyed shutter unit 22 shields the light) and view the right-eyed image I_{R} through the right-eyed shutter unit 22 (when the left-eyed shutter unit 21 shields the light, and the right-eyed shutter unit 22 lets the light pass through). Therefore, the eyes of the user can respectively receive the left-eyed image I_{L} and the right-eyed image I_{R} with binocular parallax, so that the stereoscopic image can be formed in the user's brain.

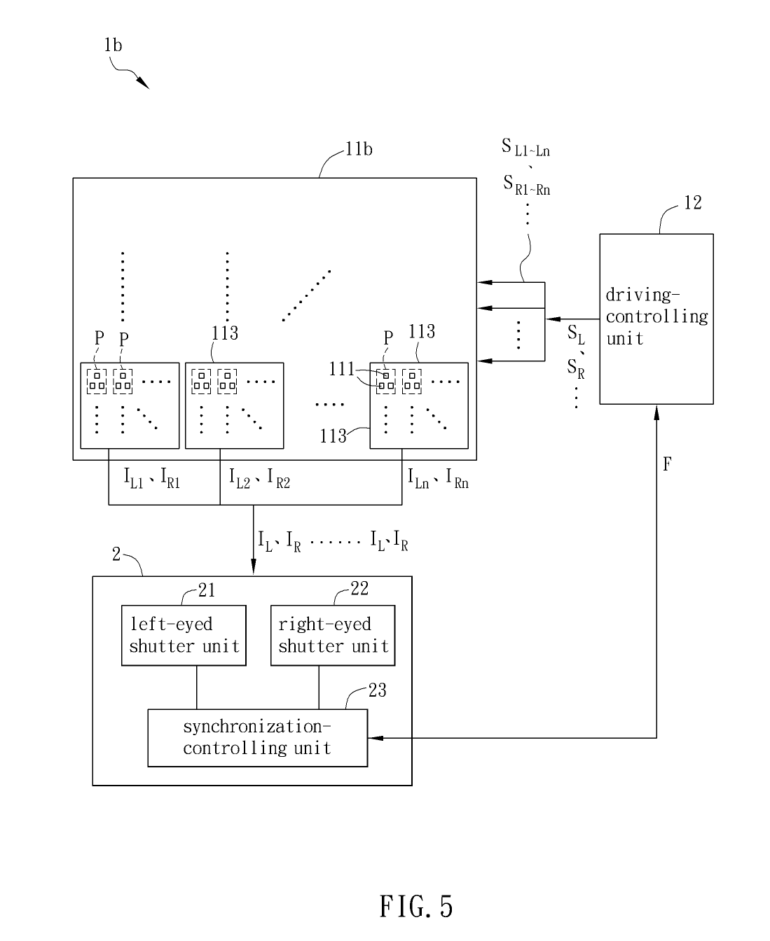

FIG. 5 is a schematic diagram of a stereoscopic display apparatus 1b in another aspect. As shown in FIG. 5, the LED display unit 11b can have a plurality of display areas 113 (for example the LED display unit 11b is formed by adjoining a plurality of small-sized LED display units). The left-eyed image signal S_{L} output by the driving-controlling unit 12 can have a plurality of left-eyed sub-image signals S_{L1˜Ln}, and each of the display areas 113 outputs a left-eyed sub-image I_{L1˜Ln} according to the corresponding left-eyed sub-image signal S_{L1˜Ln}. The left-eyed sub-images I_{L1˜Ln} form the left-eyed image I_{L}.

Similarly, the right-eyed image signal S_{R} output by the driving-controlling unit 12 can have a plurality of right-eyed sub-image signals S_{R1˜Rn}, and each of the display areas 113 outputs a right-eyed sub-image I_{R1˜Rn} according to the corresponding right-eyed sub-image signal S_{R1˜Rn}. The right-eyed sub-images I_{L1˜Ln} form the right-eyed image I_{R}.

Accordingly, the stereoscopic display apparatus 1b can be formed by a plurality of small-sized LED display units adjoined with each other, and each of the small-sized LED display unit is corresponding to each display area 113. Therefore, if the stereoscopic display apparatus 1b is applied to the outdoor large-sized display, it can be formed by adjoining a plurality of small-sized LED display units (such as small-sized LED display panels) so as to reduce the manufacturing cost. The arrangement of the display areas can be according to the horizontal direction (along the scan line), or the vertical direction (along the data line), or other direction.

To be noted, if the stereoscopic display apparatus 1b is formed by a single LED display unit, it can be still divided into plural display areas to output images. In this case, the stereoscopic display apparatus 1b can be divided into plural display areas according to the horizontal direction (along the scan line), or the vertical direction (along the data line), or other direction. Furthermore, the driving-controlling unit 12 can be divided into plural driving-controlling sub-units to share the loading of the driving-controlling unit 12, and thus the design complexity of the driving-controlling unit 12 and the manufacturing cost can be reduced.

In summary, because LED has a property of fast response, the LED display unit of the stereoscopic display apparatus of the invention can rapidly output a left-eyed image and a right-eyed image alternately. Accordingly, the black frame does not need to be inserted between the left-eyed image and the right-eyed image, so as to increase the frame rate. Besides, the stereoscopic display apparatus displays the left-eyed image and the right-eyed image by an alternate method, so the pixels of the LED display unit do not need to be divided into two display areas for the left eye and the right eye respectively. Therefore, the stereoscopic display apparatus of the invention can provide the stereoscopic images with high resolution and high quality when the viewer views the stereoscopic display apparatus by wearing the shutter apparatus (such as shutter glasses). In addition, the stereoscopic display apparatus of the invention can be applied to the outdoor display as the large-sized outdoor display apparatus, and the user can also obtain the stereoscopic images with high resolution and high quality when viewing the stereoscopic display apparatus by using the shutter apparatus.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A stereoscopic display apparatus cooperated with a shutter apparatus, comprising:
a light-emitting diode (LED) display unit having a plurality of LEDs and alternately outputting a left-eyed image and a right-eyed image.

2. The stereoscopic display apparatus as recited in claim 1, further comprising:
a driving-controlling unit electrically connected with the LED display unit and outputting a left-eyed image signal and a right-eyed image signal according to a frequency signal to drive the LED display unit.

3. The stereoscopic display apparatus as recited in claim 2, wherein the shutter apparatus has a left-eyed shutter unit, a right-eyed shutter unit and a synchronization-controlling unit which is electrically connected with the left-eyed shutter unit and the right-eyed shutter unit.

4. The stereoscopic display apparatus as recited in claim 3, wherein the synchronization-controlling unit controls the left-eyed shutter unit and the right-eyed shutter unit according to the frequency signal, so that a user alternately receives the left-eyed image through the left-eyed shutter unit and the right-eyed image through the right-eyed shutter unit.

5. The stereoscopic display apparatus as recited in claim 4, wherein the frequency signal is transmitted between the driving-controlling unit and the synchronization-controlling unit through a wired transmission or a wireless transmission.

6. The stereoscopic display apparatus as recited in claim 3, wherein each of the left-eyed shutter unit and the right-eyed shutter unit has a liquid crystal device and two polarizing elements.

7. The stereoscopic display apparatus as recited in claim 2, wherein the LED display unit has a plurality of display areas, the left-eyed image signal has a plurality of left-eyed sub-image signals, and each of the display areas outputs a left-eyed sub-image according to the corresponding left-eyed sub-image signal.

8. The stereoscopic display apparatus as recited in claim 7, wherein the left-eyed sub-images form the left-eyed image.

9. The stereoscopic display apparatus as recited in claim 2, wherein the LED display unit has a plurality of display areas, the right-eyed image signal has a plurality of right-eyed sub-image signals, and each of the display areas outputs a right-eyed sub-image according to the corresponding right-eyed sub-image signal.

10. The stereoscopic display apparatus as recited in claim 9, wherein the right-eyed sub-images form the right-eyed image.

11. The stereoscopic display apparatus as recited in claim 1, wherein the LEDs form a plurality of pixels.

12. The stereoscopic display apparatus as recited in claim 1, wherein the shutter apparatus is located between human eyes and the stereoscopic display apparatus.

13. The stereoscopic display apparatus as recited in claim 1, wherein the shutter apparatus is a shutter glasses.

14. The stereoscopic display apparatus as recited in claim 1, wherein the left-eyed image is different from the right-eyed image.
